(19) United States
(12) Patent Application Publication
(10) Pub. No.: US 2025/0385408 A1
(43) Pub. Date: Dec. 18, 2025

(54) CYLINDRICAL CELL TAB ADHESIVE TAPING METHOD, CYLINDRICAL CELL AND BATTERY

(71) Applicant: Eve Power Co., Ltd., Jingmen (CN)

(72) Inventors: Juncai SHEN, Jingmen (CN); Changquan CHEN, Jingmen (CN)

(73) Assignee: Eve Power Co., Ltd., Jingmen (CN)

(21) Appl. No.: 19/024,155

(22) Filed: Jan. 16, 2025

Related U.S. Application Data
(63) Continuation of application No. PCT/CN2024/110087, filed on Aug. 6, 2024.

(30) Foreign Application Priority Data
Jun. 18, 2024 (CN) 202410789514.3

(51) Int. Cl. H01M 50/595; C09J 7/21; H01M 50/145; H01M 50/586

(52) U.S. Cl. CPC H01M 50/595; C09J 7/21; H01M 50/145; H01M 50/586

(57) ABSTRACT

A method for taping tab adhesive of a cylindrical cell, including: cutting adhesive paper raw material to obtain a rectangular adhesive paper with a length equal to a predetermined length; a side of the adhesive paper in a lengthwise direction is made into a discontinuous vertical side; wrapping and taping the adhesive paper around the cylindrical cell so that a portion of the adhesive paper protrudes from the cell to form a protruding part, the protruding part being configured to cover tabs at both ends of the cylindrical cell; adhering the protruding part of the adhesive paper to the ends of the cell to complete taping of the cylindrical cell.

### CROSS-REFERENCE TO RELATED APPLICATION

This application is a Continuation (CON) Patent Application of International Patent Application No. PCT/CN2024/110087 filed on Aug. 6, 2024, which claims the benefit of priority of Chinese Patent Application No. 202410789514.3 filed on Jun. 18, 2024. The contents of the above applications are all incorporated herein by reference in their entireties.

### TECHNICAL FIELD

This application relates to the field of manufacturing technology for lithium cylindrical cells with adhesive taping of cylindrical cells, specifically to a method for taping the tab adhesive of a cylindrical cell, a cylindrical cell, and a battery.

### BACKGROUND

In the production and manufacturing process of lithium cylindrical cells, how to prevent cell leakage and corrosion of the aluminum casing is an important issue. Normally, the negative electrode column of the cell is separated from the casing by an insulating layer, and the casing is at a high potential. When the negative tab is exposed and comes into contact with the aluminum casing, the negative electrode column and the aluminum casing will short-circuit, and the aluminum casing will have a corrosion potential condition. The potential of the aluminum casing will be significantly reduced. At the same time, the aluminum casing comes into contact with lithium ions in the electrolyte. The low-potential aluminum casing will undergo an electrochemical reaction with lithium ions, electrons transfer from the negative electrode to the aluminum casing, and lithium ions embed into the aluminum casing to form an aluminum-lithium alloy, ultimately leading to the corrosion of the aluminum casing. In severe cases, there is even a risk of electrolyte leakage.

### SUMMARY

To avoid contact between the negative electrode and the aluminum casing, a tab adhesive paper is applied on a periphery of the cylindrical lithium cylindrical cell to separate the tabs from the aluminum casing. In the production and manufacturing process, the cell is first subjected to the taping process, and then the taped cell is inserted into the aluminum casing. During the insertion into the aluminum casing, because the gap between the aluminum casing and the cell is small, and an overlapping and adhesion part of the adhesive paper is sick, the overlapping and adhesion part of the adhesive paper attached to the periphery of the cell is easily squeezed and wrinkled by the aluminum casing due to its thickness. Wrinkles in the adhesive paper can cause the tabs to be exposed, leading to contact between the tabs and the aluminum casing, resulting in corrosion of the aluminum casing and other consequences.

According to a first aspect, this application provides a method for taping tab adhesive of a cylindrical cell, including the following steps:
S1: cutting adhesive paper raw material to obtain a rectangular adhesive paper with a length equal to a predetermined length;

One end of the adhesive paper in a lengthwise direction is made into a discontinuous vertical side to decrease an area of the adhesive paper compared to a rectangle of the same length and width;
S2: wrapping and taping the adhesive paper around the cylindrical cell so that a portion of the adhesive paper protrudes from the cell to form a protruding part, the protruding part being configured to cover tabs at both ends of the cylindrical cell;
S3: adhering the protruding part of the adhesive paper to the ends of the cell to complete taping of the cylindrical cell.

According to a second aspect, this application also provides a cylindrical cell, including a cell and an adhesive paper, the adhesive paper being taped to ends of the cell using the above-described method for taping tab adhesive of a cylindrical cell.

According to a third aspect, this application also provides a battery, including a casing and a cylindrical cell, the cylindrical cell being sealed within the casing, the cylindrical cell being the above-described cylindrical cell.

### Beneficial Effects

The method for taping tab adhesive of a cylindrical cell provided in this application involves making a side of one end of the adhesive paper in the lengthwise direction into a discontinuous vertical side. Under the premise that the length of the adhesive paper conforms to the predetermined length, this decreases the area of the adhesive paper compared to a rectangle of the same length and width, thereby decreasing the overlap area where both ends of the adhesive paper in the lengthwise direction are overlapped and adhered when the adhesive paper is taped onto the cylindrical cell. With this configuration, even if the overlapping and adhesion part of the adhesive paper are pushed and wrinkled by the aluminum casing during the process of inserting the cylindrical cell into the aluminum casing, the resulting wrinkles are significantly reduced compared to related technologies, due to the smaller overlapping and adhesion area of the adhesive paper. This reduces the likelihood of tab exposure. By adhering the part of the adhesive paper that protrudes from the cylindrical cell to the ends of the cylindrical cell, the adhesive paper can cover the tabs at the edge, further reducing the chance of tab exposure.

The cylindrical cell provided in this application has undergone taping using the taping method that results in a discontinuous vertical side made on one end of the adhesive paper in the lengthwise direction. Under the premise that the length of the adhesive paper conforms to the predetermined length, this decreases the area of the adhesive paper compared to a rectangle of the same length and width, thereby decreasing the overlap area where both ends the adhesive paper in the lengthwise direction are overlapped and adhered when the adhesive paper is taped onto the cylindrical cell. With this configuration, even if the overlapping and adhesion part of the adhesive paper are pushed and wrinkled by the aluminum casing during the process of inserting the cylindrical cell into the aluminum casing, the resulting wrinkles are significantly reduced due to the smaller overlapping and adhesion area of the adhesive paper. This reduces the likelihood of tab exposure. Furthermore, by adhering the part of the adhesive paper that protrudes from the cylindrical cell to the ends of the cylindrical cell, the adhesive paper can cover the tabs at the edge, further reducing the chance of tab exposure. Consequently, the tabs are well protected by the adhesive paper, making them less likely to expose, enhancing safety. At the same time, the reduced thickness of the adhesive paper also facilitates the insertion of the entire cylindrical cell into the casing in subsequent processes.

The battery provided in this application, due to the adoption of the aforementioned taping method for the cylindrical cells within the battery, prevents the tabs of the cylindrical cells from exposing and coming into contact with the casing, thereby greatly enhancing the safety performance of the battery.

### BRIEF DESCRIPTION OF THE DRAWINGS

FIG. 1 is a flowchart of the method for taping tab adhesive of a cylindrical cell according to this application.

FIG. 2 is a structural diagram of the adhesive paper in the method for taping tab adhesive of a cylindrical cell according to this application.

FIG. 3 is a structural diagram of the cylindrical cell after taping using the method for taping tab adhesive of a cylindrical cell according to this application.

FIG. 4 is a structural diagram of the chuck and cylindrical cell in the method for taping tab adhesive of a cylindrical cell according to this application.

FIG. 5 is a structural diagram of the adhesive paper in an alternative implementation of the method for taping tab adhesive of a cylindrical cell according to this application.

FIG. 6 is a structural diagram of the cylindrical cell after taping using the alternative implementation of the method for taping tab adhesive of a cylindrical cell according to this application.

FIG. 7 is a structural diagram of the adhesive paper in another alternative implementation of the method for taping tab adhesive of a cylindrical cell according to this application.

### REFERENCE NUMERALS

1. Cylindrical cell; 2. Adhesive paper; 201. Protruding part; 3. Chuck jaw; 4. Disk body; 5. Press block; 61. Square-shaped groove; 62. Triangular groove.

### DETAILED DESCRIPTION

In the description of this application, unless otherwise specified and limited, the terms “attached,” “connected,” and “fixed” should be understood in a broad sense. For example, they can refer to fixed connections, detachable connections, or being integrated into one; they can be mechanical connections or electrical connections; they can be directly connected or indirectly connected through intermediate media, and they can be internal connections between two components or the interrelationship of the interaction between two components. For a person of ordinary skills in the art, the specific meanings of the aforementioned terms in this application can be understood according to the specific circumstances.

In this application, unless otherwise specified and limited, the first feature being “above” or “below” the second feature can include the first and second features being in direct contact, or the first and second features not being in direct contact but in contact through other features between them. Moreover, the first feature being “above,” “on”, and “over” the second feature include the first feature being directly above and diagonally above the second feature, with the horizontal height of the first feature being higher than the second feature. The first feature being “below,” “under”, and “underneath” the second feature include the first feature being directly below and diagonally below the second feature, with the horizontal height of the first feature being lower than the second feature.

In the description of this embodiment, the terms “up,” “down,” “left,” “right,” “front,” “back” and other directional or positional relationships are based on the directions or positions shown in the accompanying drawings, for the purpose of facilitating description and simplifying operations, and do not indicate or imply that the devices or components referred to must have specific directions, constructed and operated in specific directions, and therefore should not be understood as a limitation on this application. In addition, the terms “first” and “second” are used to distinguish in description and do not have special meanings.

Referring to FIG. 1, an embodiment of this application provides a method for taping tab adhesive of a cylindrical cell, including the following steps S1 to S3.
S1: cutting adhesive paper raw material to obtain a rectangular adhesive paper 2 with a length equal to a predetermined length;

A side of the adhesive paper 2 in a lengthwise direction is made into a discontinuous vertical side to decrease an area of the adhesive paper 2 compared to a rectangle of the same length and width;
S2: wrapping and taping the adhesive paper 2 around the cylindrical cell 1 so that a portion of the adhesive paper 2 protrudes from the cylindrical cell 1 to form a protruding part 201, the protruding part 201 being configured to cover tabs at both ends of the cylindrical cell 1;
S3: adhering the protruding part 201 of the adhesive paper 2 to the ends of the cylindrical cell 1 to complete taping of the cylindrical cell 1.

For example, in step S1, the side of the adhesive paper 2 in the lengthwise direction, which has been cut to the predetermined length, can be cut or trimmed using tools such as a cutting knife or scissors. Alternatively, the side of the adhesive paper 2 can be cut or trimmed first, and then the adhesive paper 2 can be cut from an entire roll of adhesive paper (i.e., the adhesive paper raw material) to form an adhesive paper segment with a length that conforms to the predetermined length. The discontinuous vertical side of the adhesive paper 2 can serve as a starting end or a termination when wrapped around the cylindrical cell 1. In this embodiment, the discontinuous vertical side is preferred to be used as the termination.

By making a side of one end of the adhesive paper 2 in the lengthwise direction into a discontinuous vertical side, under the premise that the length of the adhesive paper 2 conforms to the predetermined length, the area of the adhesive paper 2 is decreased compared to a rectangle of the same length and width, thus decreasing the overlap area where both ends of the adhesive paper 2 in the lengthwise direction are overlapped and adhered when the adhesive paper 2 is taped onto the cylindrical cell 1. With this configuration, even if the overlapping and adhesion part of the adhesive paper 2 are pushed and wrinkled by the aluminum casing during the process of inserting the cylindrical cell 1 into the aluminum casing, the resulting wrinkles are significantly reduced due to the smaller overlapping and adhesion area of the adhesive paper 2. This reduces the likelihood of tab exposure. By adhering the part of the adhesive paper 2 that protrudes from the cylindrical cell 1 to the ends of the cylindrical cell 1, the adhesive paper 2 can cover the tabs at the edge, further reducing the chance of tab exposure.

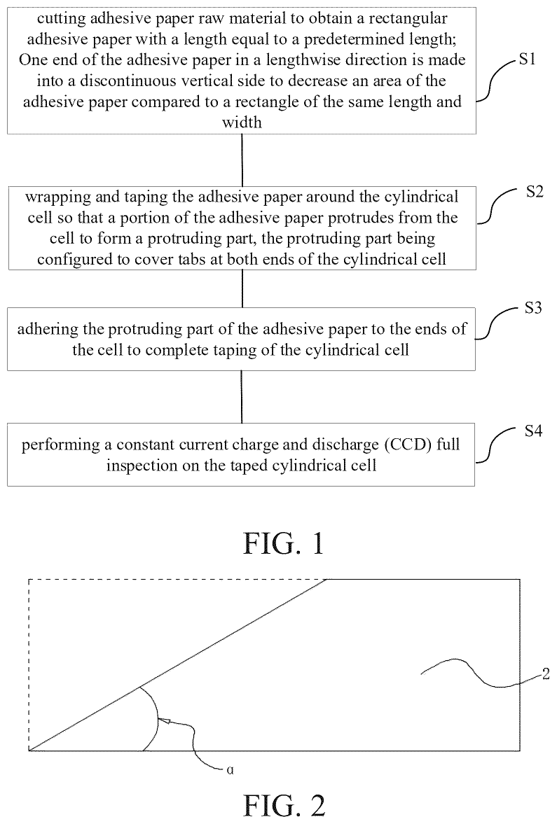

In this embodiment, referring to FIG. 2, the side of the adhesive paper 2 in the lengthwise direction can be cut into a slanted side, thus forming a right-angled triangular shape at one end of the adhesive paper 2 in the lengthwise direction. Obviously, as shown by the dashed line part in FIG. 2, the area of the right-angled triangle is smaller than that of a rectangle with the same length and width (i.e., the height of the right-angled triangle).

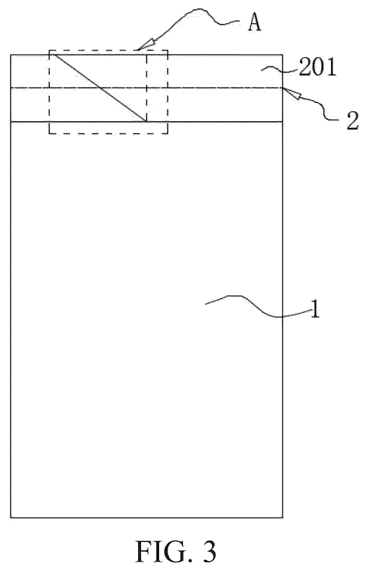

The inclination angle α of the slanted side is 10° to 80°. If the inclination angle is too small, the overlap area where both ends of the adhesive paper 2 in the lengthwise direction are overlapped and adhered will be too small, making it difficult to securely wrap and tape the adhesive paper 2 around the cylindrical cell 1. If the inclination angle is too large, the overlap area where both ends of the adhesive paper 2 in the lengthwise direction are overlapped and adhered will still be large, failing to achieve the purpose of reducing the thickness of the overlapping and adhesion part of the adhesive paper 2. The preferred inclination angle is 30°. Referring to FIG. 3, which shows the state when both ends of the adhesive paper 2 are overlapped and adhered in this embodiment, portion A in FIG. 3 is the part where the both ends of the adhesive paper 2 are overlapped and adhered. With this angle, it is possible to better balance the secure adhesion of the adhesive paper 2 and the reduction of the area of the overlapping and adhesion part of the adhesive paper 2.

In this embodiment, step S3 includes the following steps S301 and S302.
S301: gathering the protruding part 201 on one side of the ends of the cylindrical cell 1;
S302: pressing the protruding part 201 flat so that the protruding part 201 adheres to the ends of the cylindrical cell 1, completing the taping of the cylindrical cell 1.

Half of the adhesive paper 2 in a width direction has adhesive, which is taped to the top of the cylindrical cell 1, and the other half of the adhesive paper 2 in the width direction protrudes from an axial end face of the cylindrical cell 1 so that the adhesive paper 2 can cover the tabs. This part is the protruding part 201. Furthermore, the protruding part 201 of the adhesive paper 2 is pressed flat, causing the adhesive paper 2 to press against the axial end face of the cylindrical cell 1, achieving the effect of covering the tabs.

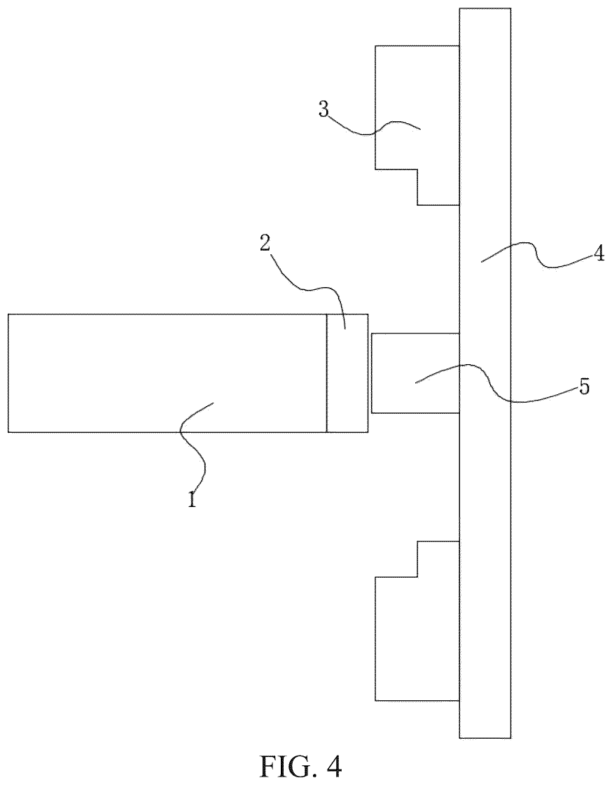

For example, referring to FIG. 4, step S301 specifically involves gathering the protruding part 201 of the adhesive paper 2 towards an axial direction on one side of the ends of the cylindrical cell 1, causing the part of the adhesive paper 2 that protrudes from the cylindrical cell 1 to gather towards the axial direction of the cylindrical cell 1. This allows the adhesive paper 2 to evenly and circumferentially cover the end face of the cylindrical cell 1 when pressed flat, ensuring that all tabs are covered by a sufficient length of the adhesive paper 2.

To achieve the effect of step S3, manual operation, robotic arm operation, and other methods can be adopted. In this embodiment, a chuck is used, and the chuck can also be a three-jaw chuck, four-jaw chuck, six-jaw chuck, etc. This embodiment uses a four-jaw chuck. Referring to FIG. 4, the chuck includes chuck jaws 3 and a disk body 4, with a cylindrical press block 5 installed along an axis on the disk body 4, and the four chuck jaws 3 move radially with the press block 5 as the center. For example, step S3 includes the following steps S311 and S312.
S311: place the chuck coaxially with the cylindrical cell 1, then open the chuck jaws 3 of the chuck to surround the protruding part 201 of the adhesive paper 2, while moving the chuck towards the cylindrical cell 1, causing the press block 5 to move inside an enclosure of the adhesive paper 2; close the chuck jaws 3 of the chuck to clamp the protruding part 201 of the adhesive paper 2 with the chuck jaws 3, causing the protruding part 201 to press against a peripheral side wall of the press block 5. Because the press block 5 is coaxial with the chuck, and the chuck is coaxial with the cylindrical cell 1, at this point, the protruding part 201 of the adhesive paper 2 gathers towards the axial direction of the end face of the cylindrical cell 1;
S312: move the chuck towards the cylindrical cell 1, press the protruding part 201 of the adhesive paper 2, which is gathered on one side of the ends of the cylindrical cell 1, on the press block 5 of the chuck, causing the gathered protruding part 201 to adhere to the ends of the cylindrical cell 1, completing the taping of the cylindrical cell 1.

In this embodiment, the method also includes the following steps S4.
S4: performing a constant current charge and discharge (CCD) full inspection on the taped cylindrical cell 1. For example, for the cylindrical cell 1 that has completed the taping operation, a CCD device is used to inspect the taped end face to prevent cylindrical cells 1 with unqualified taping from entering the next process.

In another embodiment, the side of the adhesive paper 2 in the lengthwise direction can also be cut to have a groove.

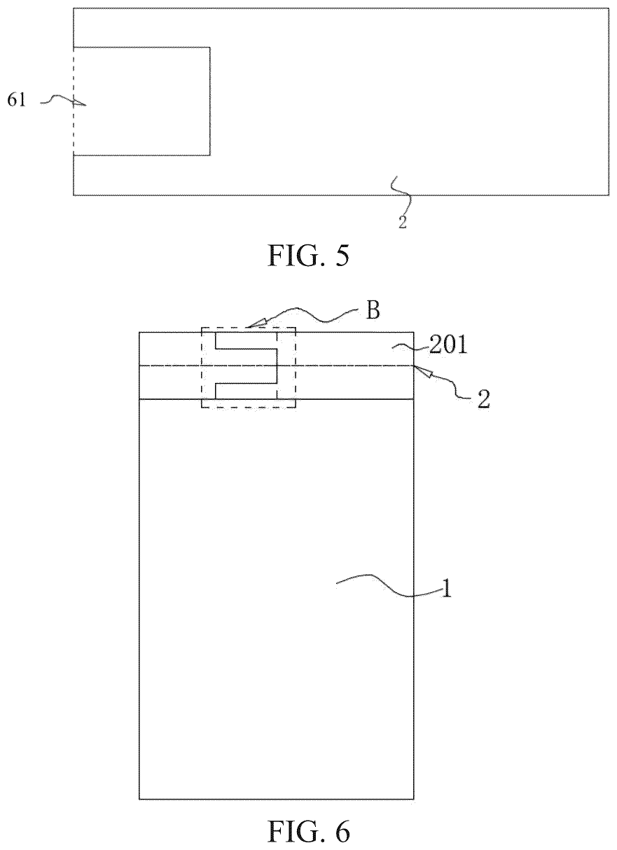

For example, referring to FIG. 5, the groove 61 on the side of the adhesive paper 2 in the lengthwise direction is square-shaped, thus forming a “II” shape that is rotated 90 degrees clockwise at one end of the adhesive paper 2 in the lengthwise direction. As such, the area at one end of the adhesive paper 2 in the lengthwise direction is significantly smaller than that of a rectangle with the same length and width (referring to the dashed line part in FIG. 5). Referring to FIG. 6, which shows the state when the both ends of the adhesive paper 2 are overlapped and adhered in this embodiment, portion B in FIG. 6 is the part where the both ends of the adhesive paper are overlapped. The uncut end of the adhesive paper 2 is pressed against a side of the groove 61, and the end of the adhesive paper 2 that has been cut out to form the groove 61 has its upper and lower sides of the groove 61 adhered to the uncut end of the adhesive paper 2, greatly reducing the overlap area of the overlapping and adhesion part at both ends of the adhesive paper 2.

In another embodiment, the side of the adhesive paper 2 in the lengthwise direction is made into a side with a triangular groove 62.

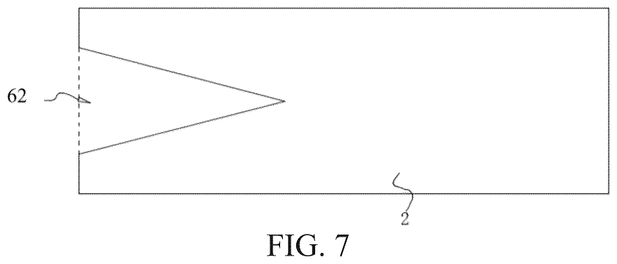

For example, referring to FIG. 7, the side of the adhesive paper 2 in the lengthwise direction can also be cut to have a triangular groove 62. The triangular groove 62 is similar in effect to the square-shaped groove 61. Compared to the square-shaped groove 61, although the overlap area when the adhesive paper 2 with the triangular groove 62 is overlapped is greater than that when the adhesive paper 2 with the square-shaped groove 61 is overlapped, the width of the upper and lower sides of the adhesive paper 2 with the triangular groove 62 is greater than that of the upper and lower sides of the adhesive paper 2 with the square-shaped groove 61. Therefore, the adhesive paper 2 with the triangular groove 62 has a greater adhesion strength than the adhesive paper 2 with the square-shaped groove 61.

This application embodiment also provides a cylindrical cell, including a cell and an adhesive paper 2, the adhesive paper 2 being taped on ends of the cell using the method for taping tab adhesive of a cylindrical cell of this application.

The cylindrical cell has undergone taping using the taping method that results in a discontinuous vertical side made on one end of the adhesive paper 2 in the lengthwise direction. Under the premise that the length of the adhesive paper 2 conforms to the predetermined length, this decreases the area of the adhesive paper 2 compared to a rectangle of the same length and width, thereby decreasing the overlap area where both ends the adhesive paper 2 in the lengthwise direction are overlapped and adhered when the adhesive paper 2 is taped onto the cylindrical cell 1. With this configuration, even if the overlapping and adhesion part of the adhesive paper 2 are pushed and wrinkled by the aluminum casing during the process of inserting the cylindrical cell 1 into the aluminum casing, the resulting wrinkles are significantly reduced due to the smaller overlapping and adhesion area of the adhesive paper 2. This reduces the likelihood of tab exposure. Furthermore, by adhering the part of the adhesive paper 2 that protrudes from the cylindrical cell 1 to the ends of the cylindrical cell 1, the adhesive paper 2 can cover the tabs at the edge, further reducing the chance of tab exposure. Consequently, the tabs are well protected by the adhesive paper 2, making them less likely to expose, enhancing safety. At the same time, the reduced thickness of the adhesive paper 2 also facilitates the insertion of the entire cylindrical cell into the casing in subsequent processes.

Embodiments of this application also provides a battery, including a casing and a cylindrical cell, the cylindrical cell being sealed within the casing, the cylindrical cell being the above-described cylindrical cell.

Since the cylindrical cell inside the battery uses the aforementioned taping method for taping, it avoids the tabs of the cylindrical cell from leaking out and coming into contact with the casing, greatly improving the safety performance of the battery.

What is claimed is:

1. A method for taping tab adhesive of a cylindrical cell, comprising:
cutting adhesive paper raw material to obtain a rectangular adhesive paper with a length equal to a predetermined length; a side of one end of the adhesive paper in a lengthwise direction being made into a discontinuous vertical side to decrease an area of the adhesive paper compared to a rectangle of the same length and width;
wrapping and taping the adhesive paper around the cylindrical cell so that a portion of the adhesive paper protrudes from the cylindrical cell to form a protruding part, the protruding part being configured to cover tabs at both ends of the cylindrical cell;
adhering the protruding part of the adhesive paper to the ends of the cell to complete taping of the cylindrical cell.

2. The method for taping tab adhesive of a cylindrical cell according to claim 1, wherein cutting adhesive paper raw material to obtain a rectangular adhesive paper with a length equal to a predetermined length comprises making the side of the adhesive paper in the lengthwise direction into a slanted side.

3. The method for taping tab adhesive of a cylindrical cell according to claim 2, wherein an inclination angle of the slanted side of the adhesive paper is 10° to 80°.

4. The method for taping tab adhesive of a cylindrical cell according to claim 1, wherein wrapping and taping the adhesive paper around the cylindrical cell so that a portion of the adhesive paper protrudes from the cylindrical cell to form a protruding part comprises wrapping and taping half of the adhesive paper in a width direction around the top of the cylindrical cell, so that another half of the adhesive paper in the width direction protrudes from an axial end face of the cylindrical cell to form the protruding part.

5. The method for taping tab adhesive of a cylindrical cell according to claim 1, wherein cutting adhesive paper raw material to obtain a rectangular adhesive paper with a length equal to a predetermined length comprises making the side of the adhesive paper in the lengthwise direction into a side with a groove.

6. The method for taping tab adhesive of a cylindrical cell according to claim 5, wherein the side of the adhesive paper in the lengthwise direction is made into a side with a square-shaped groove or a triangular groove.

7. The method for taping tab adhesive of a cylindrical cell according to claim 5, wherein the side of the adhesive paper in the lengthwise direction is cut to form the groove, and an uncut end of the adhesive paper is adhered to a side of the groove.

8. The method for taping tab adhesive of a cylindrical cell according to claim 1, wherein adhering the protruding part of the adhesive paper to the ends of the cell comprises:
gathering the protruding part on one side of the ends of the cylindrical cell;
pressing the protruding part flat so that the protruding part adheres to the ends of the cylindrical cell, completing the taping of the cylindrical cell.

9. The method for taping tab adhesive of a cylindrical cell according to claim 8, wherein gathering the protruding part on one side of the ends of the cylindrical cell comprises gathering the protruding part towards an axial direction of the cylindrical cell.

10. The method for taping tab adhesive of a cylindrical cell according to claim 8, wherein adhering the protruding part of the adhesive paper to the ends of the cell comprises:
providing a chuck, opening chuck jaws of the chuck to surround the protruding part of the adhesive paper; closing the chuck jaws to clamp the protruding part with the chuck jaws, causing the protruding part to gather on one side of the ends of the cylindrical cell;
moving the chuck towards the cylindrical cell, pressing the protruding part, which is gathered on one side of the ends of the cylindrical cell, on a press block of the chuck, causing the gathered protruding part to adhere to the ends of the cylindrical cell, completing the taping of the cylindrical cell.

11. The method for taping tab adhesive of a cylindrical cell according to claim 10, wherein the chuck comprises chuck jaws and a disk body, with a cylindrical press block installed along an axis on the disk body;
the providing the chuck comprises:
providing the chuck, placing the chuck coaxially with the cylindrical cell;
opening the chuck jaws to surround the protruding part of the adhesive paper, while moving the chuck towards the cylindrical cell, causing the press block to move inside an enclosure of the adhesive paper;
closing the chuck jaws to clamp the protruding part with the chuck jaws, causing the protruding part to press against a peripheral side wall of the press block, and the protruding part to gather towards the axial direction on one side of the end face of the cylindrical cell.

12. The method for taping tab adhesive of a cylindrical cell according to claim 1, wherein wrapping and taping the adhesive paper around the cylindrical cell so that a portion of the adhesive paper protrudes from the cylindrical cell to form a protruding part comprises using the end of the adhesive paper with the discontinuous vertical side as a starting end to wrap and adhere around the cylindrical cell, or using the end of the adhesive paper with the discontinuous vertical side as a termination to wrap and adhere around the cylindrical cell.

13. The method for taping tab adhesive of a cylindrical cell according to claim 1, further comprising:
performing a constant current charge and discharge (CCD) full inspection on the taped cylindrical cell.

14. A cylindrical cell, comprising a cell and an adhesive paper, the adhesive paper being taped to ends of the cell using a method for taping tab adhesive of a cylindrical cell, the method comprising:
cutting adhesive paper raw material to obtain a rectangular adhesive paper with a length equal to a predetermined length; a side of one end of the adhesive paper in a lengthwise direction being made into a discontinuous vertical side to decrease an area of the adhesive paper compared to a rectangle of the same length and width;
wrapping and taping the adhesive paper around the cylindrical cell so that a portion of the adhesive paper protrudes from the cylindrical cell to form a protruding part, the protruding part being configured to cover tabs at both ends of the cylindrical cell;
adhering the protruding part of the adhesive paper to the ends of the cell to complete taping of the cylindrical cell.

15. The cylindrical cell according to claim 14, wherein the side of the adhesive paper in the lengthwise direction is made into a slanted side.

16. The cylindrical cell according to claim 15, wherein an inclination angle of the slanted side of the adhesive paper is 10° to 80°.

17. The cylindrical cell according to claim 14, wherein the side of the adhesive paper in the lengthwise direction is made into a side with a groove.

18. A battery, comprising a casing and a cylindrical cell, the cylindrical cell being sealed within the casing, the cylindrical cell comprising a cell and an adhesive paper, the adhesive paper being taped to ends of the cell using a method for taping tab adhesive of a cylindrical cell, the method comprising:
cutting adhesive paper raw material to obtain a rectangular adhesive paper with a length equal to a predetermined length; a side of one end of the adhesive paper in a lengthwise direction being made into a discontinuous vertical side to decrease an area of the adhesive paper compared to a rectangle of the same length and width;
wrapping and taping the adhesive paper around the cylindrical cell so that a portion of the adhesive paper protrudes from the cylindrical cell to form a protruding part, the protruding part being configured to cover tabs at both ends of the cylindrical cell;
adhering the protruding part of the adhesive paper to the ends of the cell to complete taping of the cylindrical cell.

19. The battery according to claim 18, wherein the side of the adhesive paper in the lengthwise direction is made into a slanted side.

20. The battery according to claim 18, wherein the side of the adhesive paper in the lengthwise direction is made into a side with a groove.
